(19) United States
(12) Patent Application Publication
(10) Pub. No.: US 2025/0131022 A1
(43) Pub. Date: Apr. 24, 2025

(54) EXTRACTING EMBEDDINGS FROM MULTI-PARTY DIALOGUES AND MINING THE EMBEDDINGS USING NATURAL LANGUAGE QUERIES

(71) Applicant: Capital One Services, LLC, Mclean, VA (US)

(72) Inventors: Vivek Datla, Mclean, VA (US); Mohammad Sorower, Mclean, VA (US); Anirban Das, Mclean, VA (US)

(21) Appl. No.: 18/383,197

(22) Filed: Oct. 24, 2023

(51) Int. Cl. G06F 16/33; G06F 40/35; H04L 51/02

(52) U.S. Cl. CPC G06F 16/3344; G06F 40/35; H04L 51/02

(57) ABSTRACT

The present disclosure describes complex modeling of dialogues that allows querying of the modeled dialogues. Embeddings may be generated for each multi-party dialogue of a plurality of multi-party dialogues. Embeddings may include speaker-aware embeddings, key-utterance embeddings, and/or discourse-aware embeddings. In addition to the embeddings, a directed acyclic graph (DAG) to show a relationship between the one or more utterances of the multi-party dialogue. The embeddings and the DAG may be stored in a datastore. In response to receiving a request to identify dialogues associated with a topic, the datastore may be queried to retrieve dialogues associated with the received topic. The dialogues may be provided to the requesting party, which may use the information retrieved from the datastore to respond to a requesting party. By leveraging speaker information, key utterances, and/or discourse, the present disclosure builds a richer knowledgebase of each multi-party dialogue and provides better responses to third-party inquiries.

### FIELD OF THE INVENTION

Aspects of the disclosure relate generally to multi-party dialogue machine reading comprehension.

### BACKGROUND OF THE INVENTION

Computers and machine learning models have a difficult time comprehending multi-party dialogues. Multi-party dialogues involve two or more speakers. The two or more speakers create difficulties in identifying conversational flows. For example, computers and machine learning models have difficulties assigning utterances and/or conversational snippets to specific speakers, especially when speakers talk over one another. Furthermore, out-of-order questions and responses creates noisy context creating difficulties for computers and machine learning models to comprehend a multi-party dialogue. Accordingly, there is a need in the art to improve computers and/or machine learning models' comprehension of multi-party dialogues.

### SUMMARY OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to analyzing multi-party dialogues to improve a computer's ability to comprehend one or more topics and/or subjects discussed in a multi-party dialogue. The present disclosure leverages speaker information, key utterances, and/or discourse to build a richer knowledgebase of a multi-party dialogue, which allows third parties to query the dialogue and receive answers to those third party queries.

The present disclosure describes a computer-implemented method for complex modeling of conversations. The complex modeling may then be queried, using natural language queries, to find one or more dialogues related to a received query. The computer-implemented method may generate one or more embeddings for each multi-party dialogue of a plurality of multi-party dialogues. The plurality of multi-party dialogues may include a conversation between a customer and a representative or a discussion between a customer and a chatbot. In some instances, the computer-implemented method may transcribe a portion of the multi-party dialogues prior to generating the one or more embeddings. Additionally or alternatively, the computer-implemented method may generate a directed acyclic graph (DAG) to show a relationship between the one or more utterances of the multi-party dialogue. The DAG may be produced prior to generating the embeddings. Alternatively, the DAG may be produced as part of the embedding generation process. The one or more embeddings may be generated using a machine learning model, and the one or more embeddings may comprise one or more speaker-aware embeddings identifying each speaker in each multi-party dialogue, one or more key-utterance embeddings, and one or more discourse-aware embeddings. The computer-implemented may store the one or more embeddings for each multi-party dialogue of the plurality of multi-party dialogues in the datastore. The computer-implemented method may receive a request for multi-party dialogues comprising a topic. In some instance, the request may be received from a chatbot or a customer service representative. Upon receiving the request, the computer-implemented method may query the datastore to identify a subset of multi-party dialogues associated with the topic. The subset of multi-party dialogues may be identified using the one or more embeddings. The computer-implemented method may receive the subset of multi-party dialogues comprising the topic from the datastore and provide the subset of multi-party dialogues to a requesting party. In some instances, the computer-implemented method may analyze the subset of multi-party dialogues associated with the topic to identify an answer to an inquiry received via a chatbot and cause the chatbot to provide the answer to an inquiring party. Additionally or alternatively, the computer-implemented method may generate a report, for example, based on the subset of multi-party dialogues associated with the topic.

Corresponding apparatus, systems, and computer-readable media are also within the scope of the disclosure.

These features, along with many others, are discussed in greater detail below.

### BRIEF DESCRIPTION OF DRAWINGS

The present disclosure is illustrated by way of example and not limited in the accompanying figures in which like reference numerals indicate similar elements and in which:

FIG. 1 shows an example of a system in which one or more features described herein may be implemented;

FIG. 2 shows an example computing device in accordance with one or more aspects of the disclosure;

FIG. 3 shows an example of a process for a computer to comprehend a plurality of multi-party dialogues and respond to inquiries regarding the plurality of multi-party dialogues in accordance with one or more aspects of the disclosure; and

FIGS. 4A and 4B show an example of a multi-party reading comprehension model that may be used to identify speaker information, key utterances, and/or discourse in accordance with one or more aspects of the disclosure.

### DETAILED DESCRIPTION OF THE INVENTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects described herein may relate to question-answering systems that explicitly model the complexities of conversations to derive embeddings and/or metadata about the topics discussed during the dialogues. In particular, the present disclosure describes modeling of multi-party dialogues and/or speaker dialog flows. The modeling comprises identifying key-utterances, speaker information, and discourse between the speakers. By factoring in discourse, the present disclosure is able to learn the intricate relationships between various information exchanges that occur during a conversation. By including discourse in its analysis, the computer and/or machine learning model may be better able to comprehend and/or understand the context of a dialogue. By improving the computer and/or machine learning model's comprehension of a dialogue, the present disclosure may improve a question-answer system's ability to response to inquiries for dialogues related to a specific topic. Furthermore, by considering speaker information, such as speaker bias and linguistic variations between speakers, the present disclosure is able to develop a richer representation of the conversation that helps with downstream tasks, such as question answering, thematic summarization, questions-answers, and others. The deep-learning model described herein may generate representations of conversations that allow the conversations to be queried via natural language queries. The techniques described herein improve computers and/or machine learning models' comprehension of multi-party dialogues; a task that is simple for humans, but much more difficult for machines due, in part, to the non-linear nature of human communications.

The present disclosure leverages deep-learning based conversational question-answering systems to model complexities of conversations and/or dialogues to derive insights about conversations. The deep-learning described herein may model speaker dialog flows and/or discourse relationships to learn the relationships between various information exchanged during a conversation/dialogue. The modular representation of the conversation may consider speaker information (e.g., biases, linguistic intricacies, regional accents, etc.), as well as the information flow of the various topics being discussed, to assist downstream tasks, such as question answering, thematic summarization, questions-answers, etc. The deep-learning model described herein may passively monitor (e.g., listen) to conversations, dialogues, and/or exchanges. Based on the monitoring of a conversation, dialogue, and/or exchange, the deep-learning model may generate one or more speaker-aware embeddings, one or more key-utterance embeddings, and/or one or more discourse-aware embeddings (collectively, “one or more embeddings”). The conversation, dialogue, and/or exchange and the one or more embeddings may be stored in a datastore (e.g., a database). The datastore may then be queried, for example, using natural language queries. The queries may include one or more topics. For example, the datastore may be queried to identify one or more conversations, dialogues, and/or exchanges that included the one or more topics received from the inquiring party. The datastore may return one or more conversations, dialogues, and/or exchanges associated with the one or more topics. The one or more conversations, dialogues, and/or exchanges may be used to provide an answer to a question received by a chatbot. Additionally or alternatively, the one or more conversations, dialogues, and/or exchanges may be used to generate a report, such as a report showing compliance with one or more laws and/or regulations.

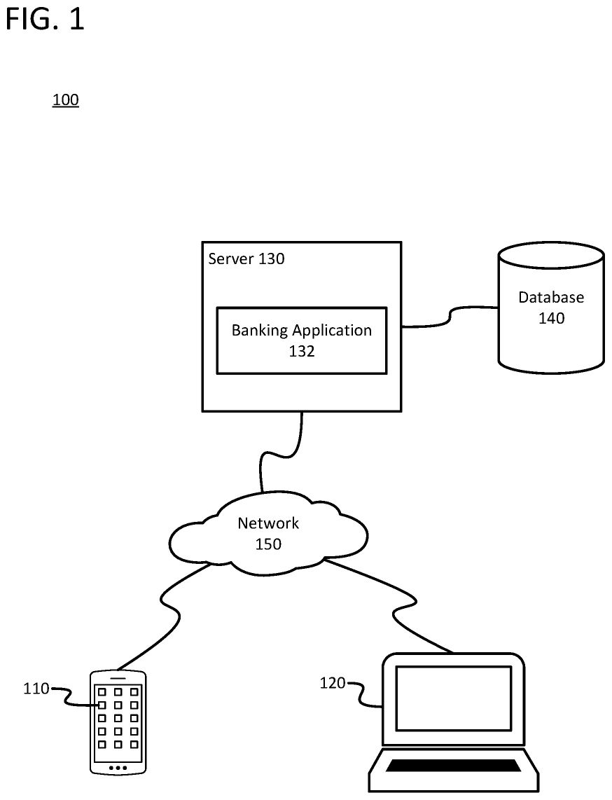

FIG. 1 shows an example of a system 100 that includes a first user device 110, a second user device 120, and a server 130, connected to a database 140, interconnected via network 150.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), and wire transfers. The banking application may comprise an authentication process to verify (e.g., authenticate) the identity of the first user prior to granting access to the banking information.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may include banking websites that allow the user to access his/her banking information and perform routine banking functions. In some embodiments, second user device 120 may include a banking application that allows the user to access his/her banking information and perform routine banking functions. The banking website and/or the banking application may comprise an authentication component to verify (e.g., authenticate) the identity of the second user prior to granting access to the banking information.

Server 130 may be any server capable of executing banking application 132. Additionally, server 130 may be communicatively coupled to database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routing banking functions. In some embodiments, banking application 132 may be the server-based software that corresponds to the client-based software executing on first user device 110 and second user device 120. Additionally, or alternatively, banking application 132 may provide users access to their account information through a website accessed by first user device 110 or second user device 120 via network 160. The banking application 132 may comprise an authentication module to verify users before granting access to their banking information. Additionally or alternatively, banking application 132 may comprise an automated customer service solution, such as a chatbot or an automated answering service.

Database 140 may be configured to store information on behalf of application 132. The information may include, but is not limited to, personal information, account information, and user-preferences. Personal information may include a user's name, address, phone number (i.e., mobile number, home number, business number, etc.), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. Additionally or alternatively, database 140 may store a plurality of multi-party dialogues, including, for examples, recorded conversations between a customer and a service agent, transcribed conversations, interactions between a customer and a chatbot, etc. Database 140 may include, but are not limited to relational databases, hierarchical databases, distributed databases, in-memory databases, flat file databases, XML databases, NoSQL databases, graph databases, and/or a combination thereof.

Network 150 may include any type of network. In this regard, network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

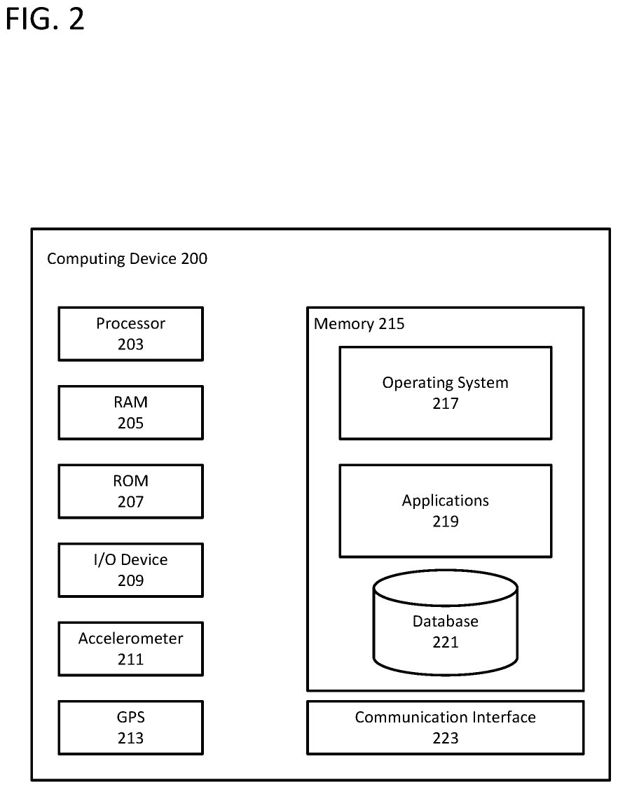

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

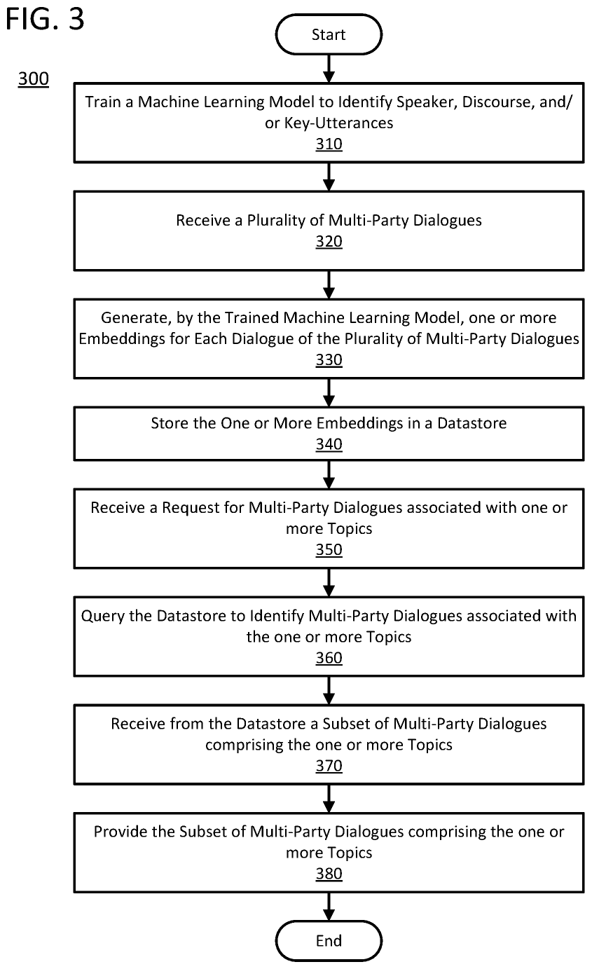

As noted above, comprehension of multi-party dialogues is difficult for computers. FIG. 3 shows a flow chart of a process for a computer to comprehend a plurality of multi-party dialogues and respond to inquiries regarding the plurality of multi-party dialogues according to one or more aspects of the disclosure. Some or all of the steps of process 300 may be performed using one or more computing devices as described herein, including, for example, the first user device 110, the second user device 120, the server 130, the computing device 200, or any combination thereof.

In step 310, a computing device may train one or more machine learning models to identify one or more components in a multi-party dialogue. Preferably, the one or more machine learning models are transformer-based models or an equivalent thereof. Alternatively, the one or more machine learning models may comprise a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or an equivalent thereof. Additionally or alternatively, the one or more machine learning models may comprise one or more decision trees. The one or more machine learning models may be trained using supervised learning, unsupervised learning, back propagation, transfer learning, stochastic gradient descent, learning rate decay, dropout, max pooling, batch normalization, long short-term memory, skip-gram, or any equivalent deep learning technique. The one or more machine learning models may be trained using a dataset comprising training data and testing (e.g., validation) data. The dataset may comprise one or more conversations, dialogues, and/or exchanges. The dataset may comprise one or more stored interactions between a customer and an agent. For example, the dataset may comprise a conversation between a customer and a customer service representative. In another example, the dataset may comprise an exchange between a customer and a chatbot. Once the one or more machine learning models are trained, the one or more machine learning models may be exported and/or deployed to identify one or more components in a multi-party dialogue.

The one or more components in a multi-party dialogue may comprise speaker information, key utterances, and discourse. The speaker information may comprise identification of individual speakers in the multi-party dialogue. Additionally or alternatively, the speaker information may comprise linguistic variations between speakers, such as regional dialects. For example, the machine-learning model may comprise one or more embeddings that identify “pop” and “soda” as regional variations referring to soft drinks. Similarly, the machine-learning model may comprise one or more embeddings that identify “tennis shoes” and “sneakers” as referring to athletic footwear. The key utterances may comprise one or more keywords and/or phrases. In some instances, the key utterances may comprise complete sentences. In further examples, the key utterances may correspond to one or more snippets (e.g., phrases, segments, portions, etc.) of a conversation, dialogue, and/or an exchange. Discourse may comprise a categorization and/or classification of a key utterance and/or snippet. For example, the categorization and/or classification may identify a key utterance and/or snippet as one or more of a clarification question, a question-answer pair, a continuation of an earlier utterance and/or snippet, an acknowledgement of an earlier utterance and/or snippet, an explanation of an earlier utterance and/or snippet, an elaboration of an earlier utterance and/or snippet, a correction to an earlier utterance and/or snippet, a contrasting remark to an earlier utterance and/or snippet, a conditional utterance and/or snippet, a background utterance and/or snippet, a narration, and/or an alternation. Discourse may also comprise identifying one or more discussions, of a plurality of discussions, that are on-going between speakers, partial and/or incomplete information flowing between the speakers, back and forth clarification questions, or incomplete conversations. Once the one or more machine learning models are trained, the one or more machine learning models may be exported and/or deployed to identify one or more components in a multi-party dialogue.

In step 320, a computing device may receive a plurality of multi-party dialogues. The plurality of multi-party dialogues may comprise at least one of a conversation between a customer and a representative or a discussion (e.g., exchange) between a customer and a chatbot. In some instances, the computing device may transcribe a portion of the multi-party dialogues, for example, prior to inputting the multi-party dialogues into the trained machine learning model to generate one or more embeddings. Transcribing the portion of multi-party dialogues may use a natural language processing algorithm. For example, audio, from either a call or a video conference, may be provided (e.g., inputted) to the natural language processing algorithm. The natural language processing algorithm may analyze the audio and output a text file with a transcription of the audio. Additionally or alternatively, the plurality of multi-party dialogues may comprise one or more text files comprising a conversation between a customer and a representative or a discussion (e.g., exchange) between a customer and a chatbot.

In step 330, the computing device may generate one or more embeddings for each multi-party dialogue of the plurality of multi-party dialogues. The one or more embeddings may be generated using the one or more trained machine learning models That is, each multi-party dialogue, of the plurality of multi-party dialogues, may be inputted into the one or more trained machine learning models. The one or more trained machine learning models may output one or more embeddings for each multi-party dialogue. The one or more embeddings may comprise one or more speaker-aware embeddings that identify each speaker in the multi-party dialogue, one or more key-utterance embeddings, and one or more discourse-aware embeddings. The one or more key-utterance embeddings may be generated using back propagation neural network training. The one or more discourse-aware embeddings may comprise a categorization and/or classification of one or more utterances of the multi-party dialogue. In some examples, the one or more trained machine learning models may generate one or more directed acyclic graphs (DAG(s)). Each DAG, of the one or more DAGs, may indicate a relationship between one or more utterances of the multi-party dialogue. In this regard, each DAG may identify related utterances and/or snippets. That is, each DAG may identify informational flows, such as a question-answer pair, a continuation of an earlier utterance and/or snippet, an acknowledgement of an earlier utterance and/or snippet, an explanation of an earlier utterance and/or snippet, an elaboration of an earlier utterance and/or snippet, a correction to an earlier utterance and/or snippet, a contrasting remark to an earlier utterance and/or snippet, a background utterance and/or snippet, a narration, an alternation, one or more of multiple discussions going on between speakers, partial and/or incomplete information flowing between the speakers, back and forth clarification questions, or incomplete conversations. In some instances, the one or more trained machine learning models may comprise a fusion layer. The fusion layer may generate one or more fused embeddings based on the one or more key-utterance embeddings, the one or more speaker-aware embeddings, and/or the one or more discourse-aware embeddings.

In step 340, the computing device may store the one or more embeddings generated for each multi-party dialogue. The one or more embeddings may be stored in a datastore, such as database 140. Additionally or alternatively, the one or more DAGs may be stored in the datastore. By storing the one or more embeddings and/or the one or more DAGs in the datastore, the system develops a richer knowledgebase for each multi-party dialogue. The knowledgebase may allow third parties to query the datastore to find dialogues that the third parties may be interested in reviewing.

In step 350, the computing device may receive a request for multi-party dialogues comprising a topic. The request may comprise a natural language inquiry. Natural language processing may be used to generate the query from the natural language inquiry. Additionally or alternatively, the request may comprise terms connected via one or more Boolean operators. The request may be received from a first device, such as a server or a user-device. Additionally or alternatively, the request may be received from a chatbot, for example, executing in a mobile application or on a website. The topic may comprise an answer to an inquiry received via the chatbot. That is, the request may comprise the question received via the chatbot. In some examples, the topic may comprise compliance with a legal requirement. For example, the request may seek to identify conversations that indicated that a customer was a military member deployed overseas. In another example, the request may seek to identify conversations that mention a disability and provide an accommodation.

In step 360, the computing device may query the datastore to identify a subset of multi-party dialogues associated with the topic. Querying the datastore may comprise generating a query statement, such as a SQL statement. The datastore may identify the subset of multi-party dialogues using the one or more embeddings. That is, the subset multi-party dialogues may comprise one or more embeddings that match the topic.

In step 370, the computing device may receive the subset of multi-party dialogues from the datastore. As noted above, the subset of multi-party dialogues may comprise the topic. In step 380, the computing device may provide the subset of multi-party dialogues comprising the topic to the requesting party (e.g., the server, the user device, the chatbot, etc.). The requesting party may analyze the subset of multi-party dialogues associated with the topic. For example, a chatbot may analyze the subset of multi-party dialogues to identify an answer to an inquiry received via the chatbot. The chatbot may then cause the answer to be provided to the inquiring party. In the legal compliance example discussed above, the computing device may generate a report, for example, based on the subset of multi-party dialogues associated with the topic. The report may indicate legal compliance with one or more laws, rules and/or regulations.

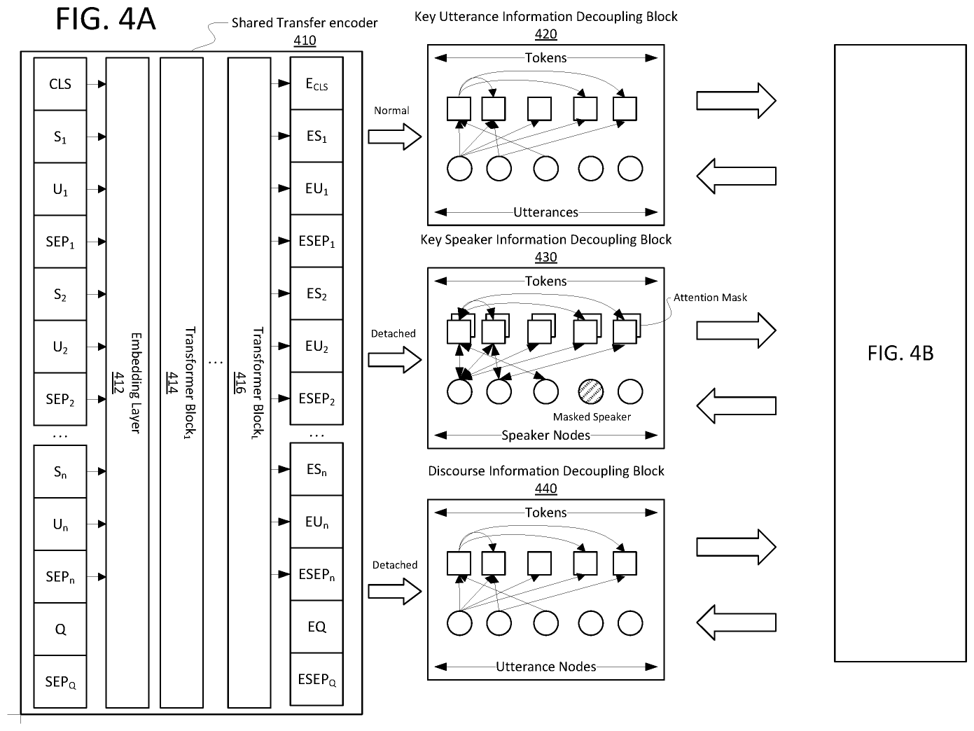

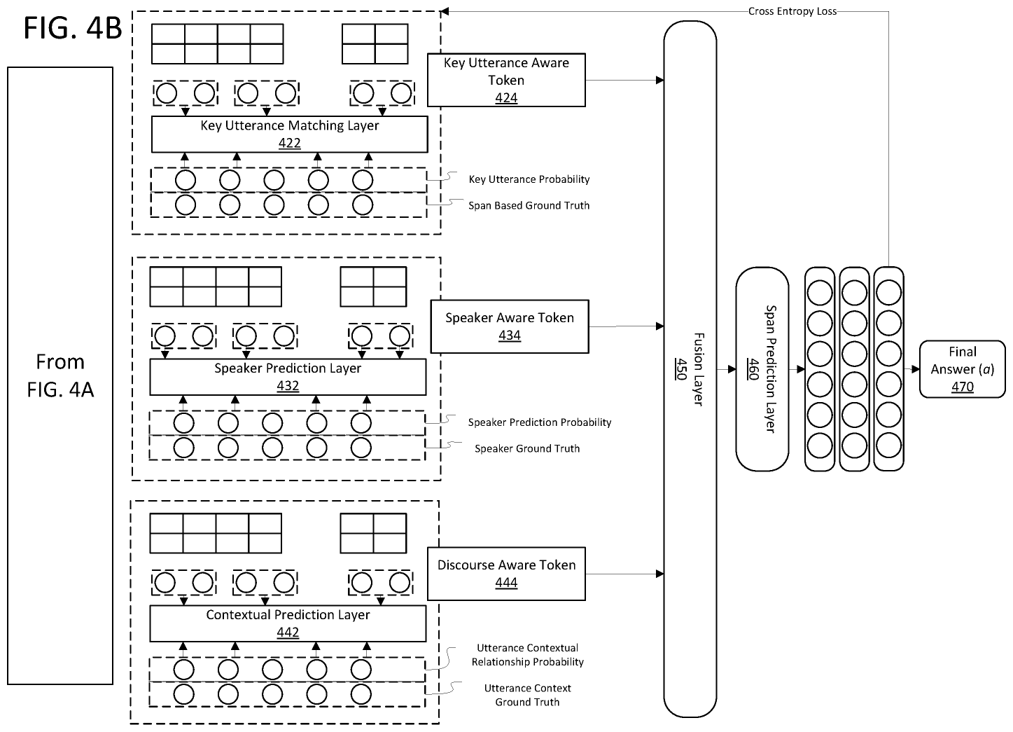

As noted above, a multi-party reading comprehension model may be used to identify speaker information, key utterances, and/or discourse. FIGS. 4A and 4B show an example of the multi-party reading comprehension model according to one or more aspects of the disclosure.

FIGS. 4A and 4B show an example of a multi-party reading comprehension model that may be used to identify speaker information, key utterances, and/or discourse in accordance with one or more aspects of the disclosure. The model comprises a shared transformer encoder 410, a key utterance information decoupling block 420, a speaker information decoupling block 430, a discourse information decoupling block 440, and a fusion layer 450. As shown in FIGS. 4A and 4B, bidirectional arrows, such as those shown in key speaker information decoupling block 430, indicate that information flows from and to both sides. Unidirectional arrows, such as those shown in key utterance information decoupling block 420 and a discourse information decoupling block 440, indicate that information only flows from start nodes to end nodes. Shared transformer encoder 410 may comprise an embedding layer 412, a first transformer block 414, and/or a second transformer block 416. While two transformer blocks are shown in FIGS. 4A and 4B, it will be appreciated that more, or fewer, transformer blocks may be used in shared transformer encoder 410.

The model shown in FIGS. 4A and 4B may receive a multi-party dialogue comprising a plurality of utterances (U₁, U₂, . . . . U_{N}, n≥1). Each utterance may comprise a speaker and a sequence of words the speaker speaks or, in the case of a chatbot, types. The speaker may be denoted as Sᵢ and each word in an utterance may be denoted as Wᵢ₁, Wᵢ₂, . . . . Wᵢ, where l≥1. A question for the multi-party dialogue may be denoted as Q. The multi-party dialogue model shown in FIGS. 4A and 4B may find an answer (a) for the question, for example, based on a continuous span of the multi-party dialogue. In some instances, the answer (a) may be an empty string, which may indicate that there is no answer to the question.

The multi-party reading comprehension model may receive the multi-party dialogue as an input. As shown in FIGS. 4A and 4B the multi-party dialogue, and the corresponding question (Q), may be inputted to shared transformer encoder 410. Multi-party dialogue and question (Q) may be inputted to shared transformer encoder 410 as a sequence. The sequence may be inputted into the encoding layer 412, the first transformer block 414, and/or the second transfer block 416 to generate a contextualized representation for each utterance. The contextual representation may comprise one or more SEP tokens that represent each utterance in the multi-party dialogue. After being generated, each of the one or more SEP tokens (e.g, E_{CLS}, ES₁, EU₁ ESEP₁, etc.) may be provided to key utterance information decoupling block 420, speaker information decoupling block 430, and/or discourse information decoupling block 440.

Key utterance information decoupling block 420 may generate one or more key utterance aware tokens 424 (H_{T}^{K}). Key utterance information decoupling block 420 may receive the one or more SEP tokens, the one or more SEP tokens may be grouped as token nodes. After grouping the one or more SEP tokens, one or more key utterance matching layers 422 may be used to exchange information amongst the different nodes. The one or more key utterance matching layers 422 may generate a question representation (H_{q}), one or more utterance representations (Hᵤᵢ), and/or one or more token representations (H_{T}). The question representation (H_{q}) may be paired with one or more utterance representations (Hᵤᵢ) to perform a key utterance prediction task. In this regard, a heuristic matching mechanism may be used to calculate a matching score of the question representation and the utterance representation. Based on the interaction between the token nodes and the key utterance aware information from the utterance nodes, key utterance information decoupling block 420 may generate one or more key utterance aware tokens 424. After being generated, the one or more key utterance aware tokens 424 (H_{T}^{K}) may be provided (e.g., sent) to fusion layer 450.

Speaker information decoupling block 430 may generate one or more speaker aware tokens 434 (H_{T}^{S}). Like key utterance information decoupling block 420, speaker information decoupling block 430 may receive the one or more SEP tokens from shared transformer encoder 410. The one or more SEP tokens may be gathered to initialize one or more unmasked speaker nodes and a masked speaker node. The representation of normal tokens may be gathered as token nodes (e.g., speaker ground truth nodes). An attention mask may be applied to the token nodes. The attention mask may correspond to a selected speaker prior to being received by speaker information decoupling block 430. One or more speaker prediction layers 432 may produce a masked speaker representation (H_{Sm}), a normal speaker representation (H_{T}), and/or one or more speaker aware tokens 434 (H_{T}^{S}). After being generated, the one or more speaker aware tokens 434 (H_{T}^{S}) may be provided (e.g., sent) to fusion layer 450.

Discourse information decoupling block 440 may generate one or more discourse aware tokens 444 (H_{T}^{D}). Like the other decoupling blocks, discourse information decoupling block 440 may receive the one or more SEP tokens from shared transformer encoder 410. The one or more SEP tokens may be gathered to initialize one or more utterance contextual relationship probabilities. The representation of normal tokens may be gathered as token nodes (e.g., utterance context ground truth). One or more context prediction layers 444 may produce one or more discourse aware tokens 444 (H_{T}^{D}). After being generated, the one or more discourse aware tokens 444 (H_{T}^{D}) may be provided (e.g., sent) to fusion layer 450.

Fusion layer 450 may receive the one or more key utterance aware tokens 424 (H_{T}^{K}), the one or more speaker aware tokens 434 (H_{T}^{S}), and/or the one or more discourse aware tokens 444 (H_{T}^{P}). Fusion layer 450 may first fuse the one or more key utterance aware tokens 424 (H_{T}^{K}) and the one or more speaker aware tokens 434 (H_{T}^{S}) according to the following:

$${H}_{T}^{cat 1} = [ {H}_{T}^{S} ; {H}_{T}^{K} ; {H}_{T}^{S} - {H}_{T}^{K} ; {H}_{T}^{K} ⊙ {H}_{T}^{S} ]$$

where ⊙ is an element-wise multiplication operation.

After the one or more key utterance aware tokens 424 (H_{T}^{k}) and the one or more speaker aware tokens 434 (H_{T}^{S}) are fused, fusion layer 450 may then fuse the resultant tokens (e.g., representations) with the discourse aware tokens 444 (H_{T}^{D}) according to the following:

$${H}_{T}^{FINAL} = [ {H}_{T}^{cat 1} ; {H}_{T}^{D} ; {H}_{T}^{cat 1} - {H}_{T}^{D} ; {H}_{T}^{cat 1} ⊙ {H}_{T}^{D} ]$$

where ⊙ is an element-wise multiplication operation. The fused embeddings may then be provided to span prediction layer 460.

Span prediction layer 460 may compute (e.g., calculate) the start and end probability distributions over the tokens. Given the ground truth label of answer span [aₛ, dₑ], cross entropy loss may be used to train, or retrain, the model. If the dataset contains an unanswerable question, span prediction layer 460 may indicate that the question is unanswerable. In some instances, span prediction layer 460 may adjust (e.g., readjust) trainable weights. If the dataset contains an answerable question, binary cross entropy loss may be used to determine final answer 470 (e.g., a). As noted above, final answer 470 may comprise one or more dialogues associated with a topic received in an inquiry and/or query. For example, final answer 470 may comprise a response to an inquiry received from a chatbot. In this regard, the chatbot may request an answer to a question received from a requesting, or an inquiring, party. The chatbot may not have the answer readily available. The chatbot may pass the question to a server that queries the datastore comprising the multi-party dialogues, as well as the one or more embeddings associated with each of the multi-party dialogues and/or one or more DAGs associated with each of the multi-party dialogues. In response to the query, the server may receive a subset of multi-party dialogues that are related to the question received via the chatbot. The subset of multi-party dialogues may be analyzed to identify a first answer that most likely answers the question. The chatbot may than provide the answer to the requesting party.

Using the techniques described above, the present disclosure allows for the complex modeling of multi-party dialogues. The complex models may than be queried to identify dialogues associated with a topic indicated by the query. By factoring in discourse, the present disclosure is able to learn the intricate relationships between various information exchanges that occur during a dialogue. The addition of speaker information, such as speaker bias and linguistic variations between speakers, allows the present disclosure to develop a richer representation of a dialogue that allows question-answering systems to find dialogues associated with specific topics. The techniques described herein improve computers and/or machine learning models' comprehension of multi-party dialogues; a task that is simple for humans, but much more difficult for machines due, in part, to the non-linear nature of human communications.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
generating, by a computing device and using a machine learning model, one or more embeddings for each multi-party dialogue of a plurality of multi-party dialogues, wherein the one or more embeddings comprise:
one or more speaker-aware embeddings identifying each speaker in each multi-party dialogue,
one or more key-utterance embeddings, and
one or more discourse-aware embeddings, wherein the one or more discourse-aware embeddings comprise a classification of one or more utterances of a multi-party dialogue;
receiving, by the computing device and from a first device, a request for multi-party dialogues comprising a topic;
querying, by the computing device, a datastore comprising the plurality of multi-party dialogues to identify a subset of multi-party dialogues associated with the topic, wherein the subset of multi-party dialogues is identified using the one or more embeddings;
receiving, by the computing device, the subset of multi-party dialogues comprising the topic; and
providing, by the computing device and to the first device, the subset of multi-party dialogues comprising the topic.

2. The method of claim 1, further comprising receiving the plurality of multi-party dialogues, wherein the plurality of multi-party dialogues comprises at least one of:
a conversation between a customer and a representative; or
a discussion between a customer and a chatbot.

3. The method of claim 1, further comprising generating a directed acyclic graph (DAG) indicating a relationship between the one or more utterances of the multi-party dialogue.

4. The method of claim 1, further comprising:
transcribing, by the computing device and prior to the generating the one or more embeddings, a portion of the multi-party dialogues.

5. The method of claim 1, wherein the generating the one or more embeddings for each multi-party dialogue comprises generating one or more fused embeddings based on the one or more key-utterance embeddings, the one or more speaker-aware embeddings, and the one or more discourse-aware embeddings.

6. The method of claim 1, further comprising:
generating the one or more key-utterance embeddings using back propagation neural network training.

7. The method of claim 1, wherein the topic comprises an answer to an inquiry received via a chatbot.

8. The method of claim 1, wherein the topic comprises a legal requirement.

9. The method of claim 1, further comprising:
analyzing the subset of multi-party dialogues associated with the topic to identify an answer to an inquiry received via a chatbot; and
causing, by the computing device, the chatbot to provide the answer to an inquiring party.

10. The method of claim 1, further comprising:
generating, based on the subset of multi-party dialogues associated with the topic, a report.

11. A computing device comprising:
one or more processors; and
memory storing instructions that, when executed by the one or more processors, cause the computing device to:
generate, using a machine learning model, one or more embeddings for each multi-party dialogue of a plurality of multi-party dialogues, wherein the one or more embeddings comprise:
one or more speaker-aware embeddings identifying each speaker in each multi-party dialogue,
one or more key-utterance embeddings, and
one or more discourse-aware embeddings, wherein the one or more discourse-aware embeddings comprise a classification of one or more utterances of a multi-party dialogue;
receive, from a chatbot executing on a first device, a request for multi-party dialogues comprising an answer to an inquiry received via the chatbot;
query a datastore comprising the plurality of multi-party dialogues to identify a subset of multi-party dialogues that may comprise the answer, wherein the subset of multi-party dialogues is identified using the one or more embeddings;
receive the subset of multi-party dialogues that may comprise the answer;
analyze the subset of multi-party dialogues to identify a first answer that most likely answers the inquiry; and
cause the chatbot to provide the first answer to an inquiring party.

12. The computing device of claim 11, wherein the instructions, when executed by the one or more processors, cause the computing device to receive the plurality of multi-party dialogues, wherein the plurality of multi-party dialogues comprises at least one of:
a conversation between a customer and a representative; or
a discussion between a customer and the chatbot.

13. The computing device of claim 11, wherein the instructions, when executed by the one or more processors, cause the computing device to generate a directed acyclic graph (DAG) indicating a relationship between the one or more utterances of the multi-party dialogue.

14. The computing device of claim 11, wherein the instructions, when executed by the one or more processors, cause the computing device to generate one or more fused embeddings based on the one or more key-utterance embeddings, the one or more speaker-aware embeddings, and the one or more discourse-aware embeddings.

15. The computing device of claim 11, wherein the instructions, when executed by the one or more processors, cause the computing device to generate one or more key-utterance embeddings using back propagation neural network training.

16. A non-transitory computer-readable medium comprising instructions that, when executed, configure a computing device to:
generate, using a machine learning model, one or more embeddings for each multi-party dialogue of a plurality of multi-party dialogues, wherein the one or more embeddings comprise one or more discourse-aware embeddings;
receive, from a first device, a request for multi-party dialogues comprising a topic;
query a datastore comprising the plurality of multi-party dialogues to identify a subset of multi-party dialogues associated with the topic, wherein the subset of multi-party dialogues is identified using the one or more embeddings; and
receive the subset of multi-party dialogues comprising the topic.

17. The non-transitory computer-readable medium of claim 16, wherein the instructions, when executed, configure the computing device to:
transcribe, prior to generating the one or more embeddings, a portion of the multi-party dialogues.

18. The non-transitory computer-readable medium of claim 16, wherein the instructions, when executed, configure the computing device to:
store the one or more embeddings for each multi-party dialogue of the plurality of multi-party dialogues in the datastore.

19. The non-transitory computer-readable medium of claim 16, wherein the instructions, when executed, configure the computing device to:
generate one or more key-utterance embeddings using back propagation neural network training.

20. The non-transitory computer-readable medium of claim 16, wherein the instructions, when executed, configure the computing device to generate, based on the subset of multi-party dialogues, a report, wherein the report indicates legal compliance with one or more regulations.
